(19) United States
(12) Patent Application Publication
(10) Pub. No.: US 2005/0279124 A1
(43) Pub. Date: Dec. 22, 2005

(54) Collapsible folding cooler

(75) Inventor: John Maldonado, Katy, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: Igloo Products Corp., Katy, TX (US)

(21) Appl. No.: 11/155,113

(22) Filed: Jun. 16, 2005

Related U.S. Application Data
(60) Provisional application No. 60/580,863, filed on Jun. 17, 2004.

(51) Int. Cl. F25B 21/02; F25D 3/08; A47J 39/00; B65D 81/38; A47J 41/00; B65D 83/72

(52) U.S. Cl. 62/457.7; 220/592.2

(57) ABSTRACT

An insulated cooler that can be collapsed is disclosed. The cooler has a securing mechanism that allows a user to maintain the cooler in collapsed state indefinitely as well as reversibly convert the cooler from a collapsed state for storage to an expanded state for use. The securing mechanism may also allow a user to secure an item, such as a towel, to the exterior of the cooler while in the expanded state. The cooler can have a bottom, one or more sides, and a top. The shape of the coolers can be determined by selecting an appropriate number of side faces. The exterior of the cooler may have pockets, handles, or adjustable straps to increase the usefulness of the cooler. The securing mechanism may also be used to selectively secure an object or item onto the cooler when the cooler is in an expanded state.

### CROSS REFERENCE TO RELATED APPLICATIONS

This application is a Non-provisional application claiming priority to U.S. Provisional Application Ser. No. 60/580,863, entitled, “Collapsible Folding Cooler,” by John Maldonado, filed Jun. 17, 2004, hereby incorporated by reference in its entirety herein.

### BACKGROUND OF THE INVENTION

1. Field of the Invention

The present invention relates generally to the field of coolers and, more specifically, to a cooler that can be folded to facilitate storage. More particularly, the present invention relates to a softside cooler that can hold items while in an expanded state, but that can be collapsed when not in use to require less storage space.

Softside coolers typically comprise coolers made of fabric providing thermal insulation for a cavity that may hold food and/or beverages. Softside coolers tend to be popular because they are often collapsible and may be more fashionable than a hardside cooler as a softside cooler may contain pockets or allow that attachment of accessories or gadgets.

2. Description of the Related Art

Generally, insulated containers, sometimes referred to as coolers and/or ice chests, have been used for many years to transport food and beverages between locations while keeping the contents at a desired temperature. Typically, the insulated coolers are used to carry cold items such as soda, beer, sandwiches, ice cream, fish, meat, and so on. Alternatively, the insulated coolers can be used to transport hot items such as casseroles, lasagna, vegetables, and so on.

Coolers may typically be categorized as hardsided or softsided. Hardsided coolers include coolers having an outside body made from hard plastic, such as blow molded or injection molded plastics. These hardsided coolers offer protection for the contents therein; however, the use of hard plastics hampers the ability of the hardsided coolers from having any external storage. Further, hardsided coolers maintain their shape, whether or not the coolers are in use. This has resulted in the need for excess storage space, as the hard coolers occupied their full volume even when not in use.

Various attempts have been made to address this storage space issue. U.S. Pat. No. 6,736,309 B1 (issued May 18, 2004) describes a quick erecting, disposable cooler that is supplied as a flat blank of corrugated material. U.S. Pat. No. 5,853,121 (issued Dec. 29, 1998) describes a foldable laminated paperboard chest for transporting and storing food products, and a one-piece laminated paperboard blank from which such the chest is constructed. While these products can be stored flat, they are not easily reusable. Additionally, these products do not provide any external storage or versatility of the internal cavity.

In contrast to hardside coolers, softside coolers typically comprise coolers made of a pliable material, such as fabric, and may include thermal insulation between the pliable material and the contents contained in the inside cavity, such as food and/or beverages. Softside coolers tend to be popular because they are collapsible and may contain external storage, such as pockets, for accessories.

Although softside coolers may be collapsible, often the coolers do not stay in a compact, collapsed state due to the insulated fabric used. Thus, to decrease the volume of the collapsed cooler and maintain the minimum required storage space often an additional object, such as a heavy box, must be placed on top of the softside cooler. While this may be acceptable while storing the cooler in a semi-permanent place such as a garage, it would be inconvenient to bring such an object while traveling or on a family outing.

An example of a collapsible cooler utilizing a hook and loop attachment mechanism (i.e. a fastening mechanism offered under the brand name VELCRO), is shown in the final figures of this disclosure, FIGS. 8A-C. A strap “S” is adapted to secure the cooler in the collapsed state via hook “H” and loop “L” fasteners. As shown in FIG. 8B, a portion of the hook and loop mechanism is secured to the cooler (in this case the hook portion “H”). When expanded, the hook portion of the fastening mechanism remains visible and may be considered unsightly to some. Further, the hook and loop feature provides mono-functionality: to secure the cooler in the collapsed state. It would be advantageous to provide a fastening means which is esthetically pleasing, and further provides dual functionality of securing an object, such as a newspaper or towel, to the cooler when expanded.

In light of the foregoing, it would be desirable to provide a cooler that is collapsible, provides external storage, has a versatile internal cavity, effectively maintain the temperature of their contents, and includes a mechanism to maintain the compressed volume of the cooler for ease of storage until the cooler is needed again. Further, it would be desirable to provide a collapsible cooler where the mechanism to maintain the cooler in a compressed state could also provide utility while the cooler was in an expanded state. Finally, it would be advantageous if the same mechanism that maintained the cooler in the compressed state could have a dual function of supporting accessories, such a beach towels, for example, onto the cooler in the expanded state.

### SUMMARY OF THE INVENTION

The insulated cooler described herein is a collapsible insulated cooler that attempts to overcome some of the disadvantages described above. In some embodiments, the cooler may be comprised of fabric and an insulating material such as closed cell foam. The cooler may have a securing mechanism for maintaining the cooler in its compressed, folded state when not in use. The cooler may include a waterproof liner to prevent leakage, as well as other convenience features such as handles, shoulder straps, pockets, and so on.

In some embodiments, the cooler comprises a bottom, a top, at least one side made of substantially pliable material, and means for securing the cooler in a collapsed state. In some embodiments, the means for securing the cooler in a collapsed state may comprise an elastic band or elastic shock cord. In an alternative embodiment, the means for securing the cooler in a collapsed state may comprise a strap with snaps or hook and eye closures. The means for securing the cooler may also be able to secure an item, such as a towel, to the exterior of the cooler. In some embodiments, the top may be reversibly attachable to the cooler by a zipper or elastic fitting. In one embodiment, the cooler may include a waterproof cavity. Additionally, the cooler may include an internal divider or internal pocket. In an alternative embodiment, at least of the one of the top, side, or bottom of the cooler may comprise a substantially rigid material. In one embodiment, the cooler contains a cylindrical cavity defined by a top, bottom, and at least one side.

In one embodiment, the cooler may include both an expanded and compressed state and comprise a rectangular cross-section having four sides, a top, and a bottom. Further, the four sides, top, and bottom may comprise softside material and be collapsible. The cooler may include means for retaining the cooler in a compressed state such as an elastic strap or shock cord attachable to the top. In an alternative embodiment, the elastic strap or shock cord may secure an item to the exterior of the cooler while the cooler is in an expanded state. In another embodiment, the cooler may include an interior ice pack packet. The cooler may also include a heat sealed liner.

In another embodiment, the cooler may comprise a bottom, at least one side, and top where one of the bottom, at least one side, and top comprises a substantially pliable material such that the cooler may be collapsed from an expanded state. The cooler may include an elastomeric band or strap to retain the cooler while in the collapsed state. In some embodiments, the elastomeric band or strap has a dual function: the elastomeric band or strap may also be utilized to selectively secure an object, such as a beach towel, onto the cooler, while the cooler is in the expanded state.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1A shows a perspective view of an embodiment of the present disclosure of a cooler 1 having a rectangular cross section in an expanded state.

FIG. 1B shows a perspective view of the embodiment of FIG. 1A of the present disclosure of the cooler in a compressed state.

FIG. 2 shows a side view of the embodiment of FIG. 1B of the present disclosure.

FIG. 3A shows a front view of an embodiment of the present disclosure of a cooler 1 in a compressed state and a securing mechanism 5 in an unfastened position.

FIG. 3B shows a front view of the embodiment of FIG. 3A of the present disclosure of the cooler in a compressed state and the securing mechanism retaining the cooler in the compressed state.

FIG. 4A shows a perspective view of an embodiment of the present disclosure of a cooler 1 having one side 3 with the cooler 1 in an expanded state.

FIG. 4B shows a perspective view of the embodiment of FIG. 4A of the present disclosure in a collapsed state.

FIG. 5A shows a perspective view of an embodiment of the present disclosure of a cooler 1 in an expanded state with a securing mechanism 5 attached to a retention device 12.

FIG. 5B shows a perspective view of the embodiment of FIG. 5B of the present disclosure with the securing mechanism in an unfastened position.

FIG. 6A shows a rear view of an embodiment of the present disclosure of a cooler 1 in an expanded state.

FIG. 6B shows a rear view of the embodiment of FIG. 6A of the present disclosure having a securing mechanism 5 not attached to a retention device 12.

FIG. 7 shows an embodiment of the present disclosure showing the dual functionality of a securing mechanism

FIG. 8 shows a prior art collapsible cooler, utilizing a hook and loop system.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

Illustrative embodiments of the invention are described below as they might be employed in the use of designs for collapsible softside coolers. As used herein, cooler may be utilized interchangeably with cooler, ice chest, insulated container, and the like, and each term (cooler, ice chest, insulated container) is to be given its ordinary meaning. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Further aspects and advantages of the various embodiments of the invention will become apparent from consideration of the following description and drawings.

While articles are described in terms of “comprising” various components (interpreted as meaning “including, but not limited to”), the articles can also “consist essentiall of” or “consist of” the various components and steps, such terminology should be interpreted as defining essentially closed-member groups.

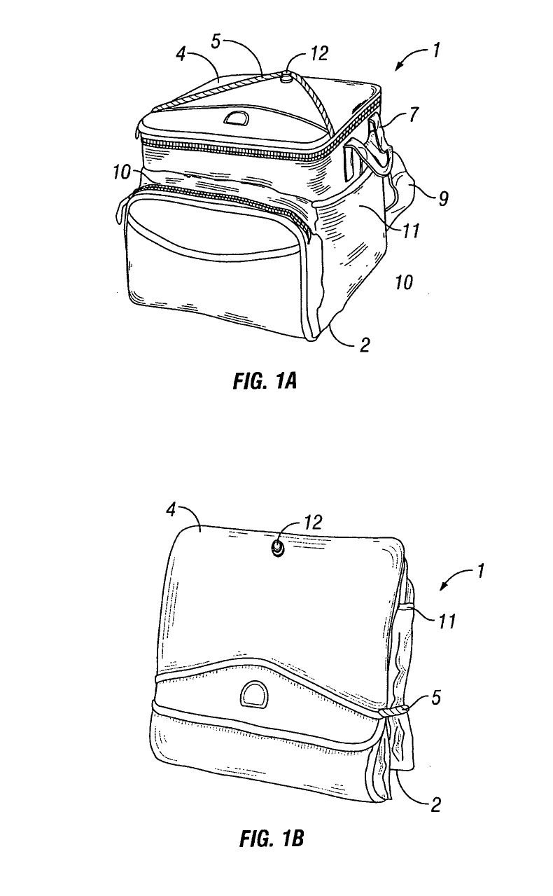

As shown in FIG. 1A, the cooler 1 may comprise a bottom 2, at least one side 3, a top 4, and a securing mechanism 5. The bottom 2, at least one side 3, and top 4 define an interior space 6. One or more of the bottom 2, at least one side 3, and top 4 can be made of an insulated material. The bottom 2, at least one side 3, and top 4 may all be made of an insulated material. The bottom 2, at least one side 3, and top 4 can independently be made of a solid, hard material (“hard sided”) or of a flexible material (“soft sided”). Various combinations of materials can be used as well. For example, the bottom 2 and top 4 can be hard sided, while the at least one side 3 can be soft sided. Example materials include plastic, polyvinylchloride (“PVC”), nylon, fabric, foam, and so on.

As shown in FIG. 1A, the exterior of the cooler 1 may include a handle 7, shoulder strap 9, and/or pocket 10. The top 4 of the cooler 1 may include a retention device 12, connectable to a securing mechanism 5. The retention device 12 may comprise a knob, or hook, could be used to connect to the securing mechanism 5. In some embodiments, the retention device 12 may cause the securing mechanism to remain taut when not in use to retain the cooler 1 in a collapsed state.

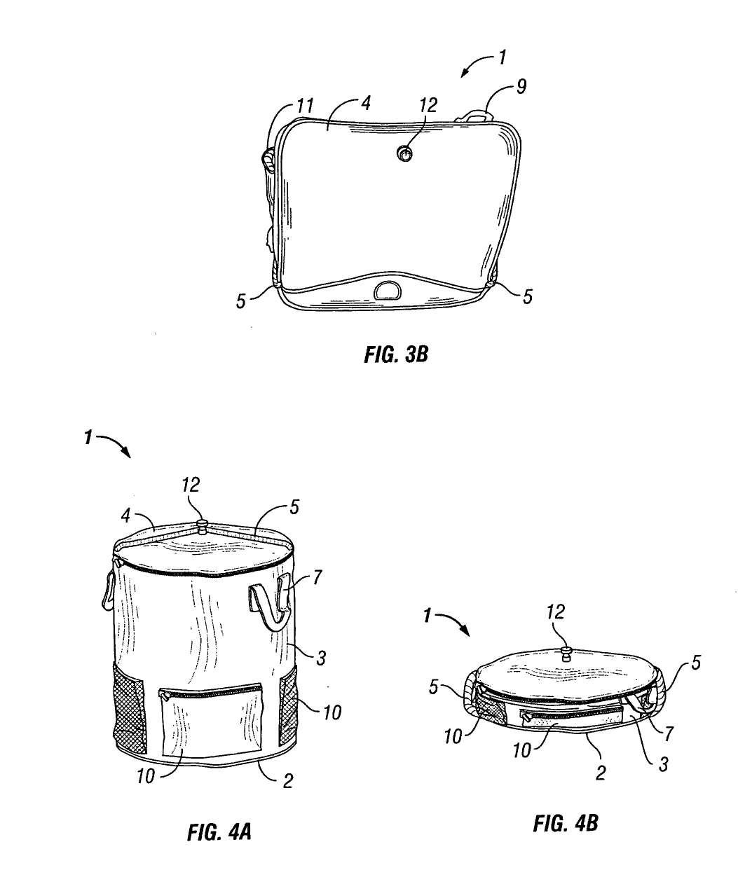

As shown in FIG. 1B, cooler 1 may be compressed by bringing the top 4 together with at least one side 3 causing a bottom 2 and any remaining sides 3 to collapse. The cooler 1 may include a securing mechanism 5 to retain the cooler 1 in its compressed state. The securing mechanism 5 may be a shock cord or elastic cord attachable to the top 4 as shown in FIG. 3A.

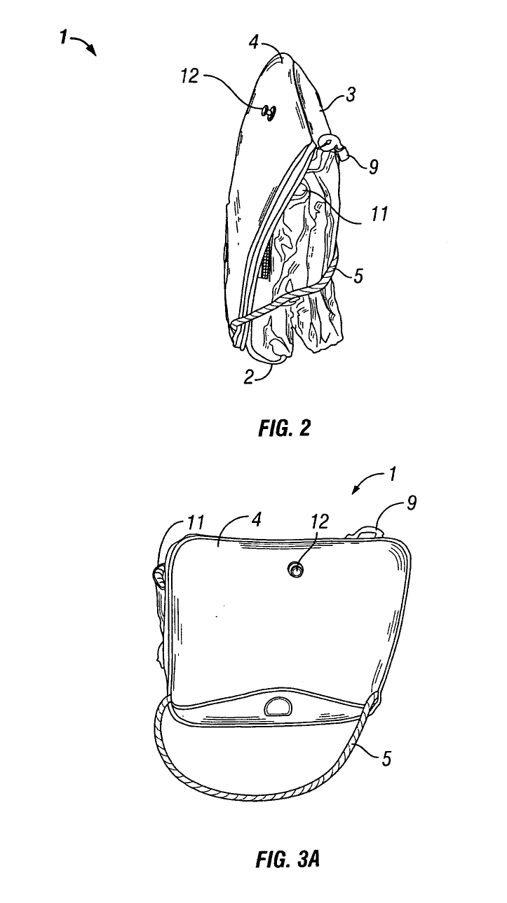

FIG. 2 shows the side view of the cooler 1 in a compressed state. The bottom 2 and three sides have been collapsed allowing the top 4 and one side 3 to come together. The volume of inner cavity 6 (not shown) is decreased as illustrated in FIGS. 1B and 2 in comparison to FIG. 1A. The cooler 1 may include a retention mechanism 5 to maintain the cooler 1 in a compressed state.

FIGS. 3A and 3B show the front view of one embodiment of a cooler 1 in a collapsed state. As shown in FIG. 3B, a securing mechanism 5 may be attached to the top 4 of the cooler 1 and be extended around cooler 1 to maintain the cooler 1 in a collapsed state. In FIG. 3B the securing mechanism 5 is shown in an unfastened position.

One embodiment of the present disclosure having one side is generally round (cylindrical) or oval in cross section as shown in FIGS. 4A-4B. The cooler 1 may include a securing mechanism 5 that is connected to a retention mechanism 12 while the cooler 1 is expanded. In some embodiments, the cooler 1 may have only one side 3 that may include a pocket 10, handle 7, and/or shoulder strap 9 (not pictured). The cooler 1 may be compressed by folding in the one side 3 while bringing the top 4 and the bottom 2 together. In the embodiment shown in FIG. 4A, the cooler 1 may take a circular shape when in the collapsed state as shown in FIG. 4B and the securing mechanism 5 may be used to maintain the cooler 1 in the collapsed state.

As would be apparent to one skilled in the art, the number of side of the cooler 1 can generally be any number, such as 1, 3, 4, 5, 6, and so on. As shown in FIGS. 4A-4B and discussed above, embodiments having 1 side generally would have a circular or oval cross section. Alternative embodiments having three sides can be triangular in cross section (such as right triangular, isosceles, scalene). Other embodiments having four sides can have various cross sections such as square, rectangular, trapezoid, or other shapes.

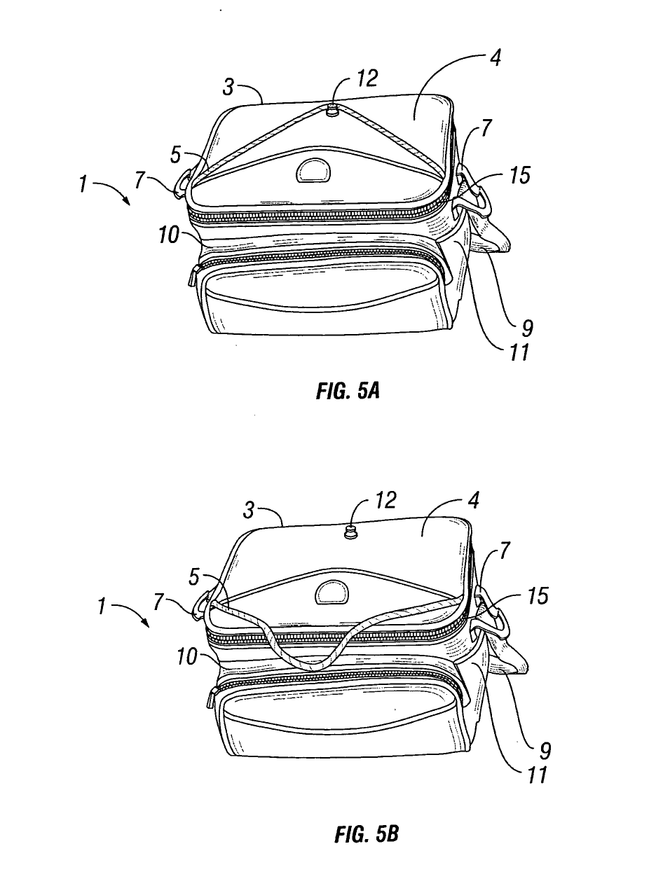

In one embodiment, the top 4 of cooler 1 can be reversibly attached to the top edge(s) of the one or more sides 3. The reversible attachment allows the top 4 to be quickly and easily opened to allow access to the interior space 6 of the cooler where various items can be stored. The reversible attachment can generally be any type of reversible attachment such as a zipper or an elastic fitting. FIGS. 5A and 5B show an embodiment of the present disclosure wherein a cooler 1 has a top 4 reversibly attached to the cooler 1 by a zipper 15.

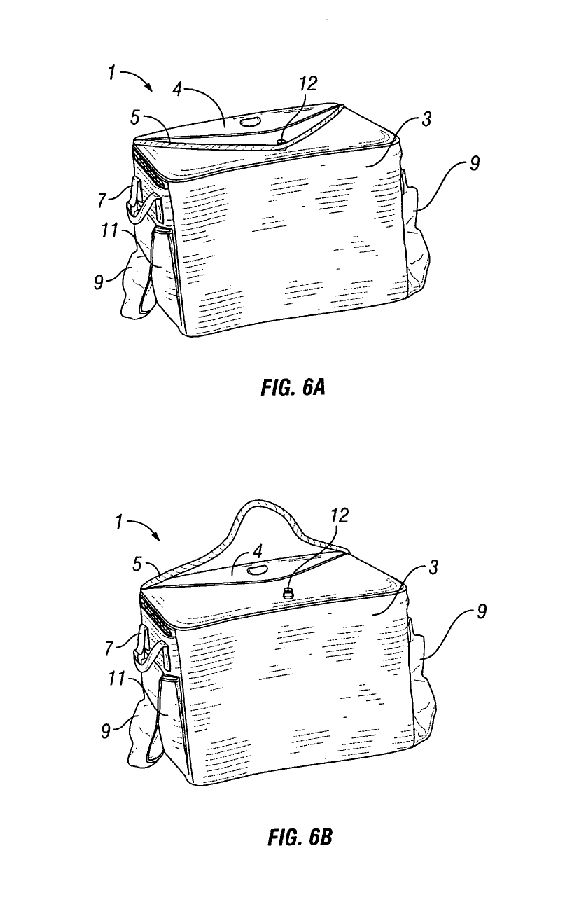

FIGS. 6A and 6B show a rear view of an embodiment of a cooler 1 that has no pockets or handles on the back side 3 of cooler 1. In some embodiments, cooler 1 may include a side slip pocket 11, handle 7, and/or should strap 9 on a side of the cooler.

In each embodiment a cooler 1 can be collapsed to occupy a smaller overall volume than when it is in its expanded state. The expanded state is used when transporting contents such as food or beverages. The collapsed state can be used when the cooler is not in use in order to conserve storage space. One or more of the sides or lid can be folded or otherwise manipulated to collapse the cooler. For example, in one embodiment a square or rectangular cooler can be collapsed by bringing the leading edges of the bottom and the top towards each other, collapsing the front and two sides. The collapsed state in this example would be a roughly flat square or rectangle. The securing mechanism 5 could be used to hold the cooler 1 in its collapsed state. In an alternative example, a cooler 1 having one side 3 and a circular cross section could be collapsed by bringing the bottom 2 and the top 4 together, with the side 3 collapsing between them. The collapsed state in this example would be a roughly flat circle. Again, the securing mechanism 5 could be used to hold the cooler 1 in its collapsed state.

The volume of the expanded state can generally be any volume. Larger volumes are preferred when the user needs to carry large quantities of materials, while smaller volumes are preferred when the user needs to carry smaller quantities of materials. Coolers are frequently described in terms of their ability to hold a particular number of beverage cans. For example, a cooler may be able to hold 4, 6, 8, 10, 12, 14, 16, 18, 20, 22, 24, 26, 28, 30, 32, 34, 36, or more beverage cans. A typical soda can is a cylinder about 5 inches in height by 2.5 inches in diameter (12.7 cm in height by 6.35 cm in diameter).

The securing mechanism 5 can generally be any securing mechanism effective to hold the cooler in its collapsed state. In some embodiments, as described with respect to FIG. 8, the securing mechanism 5 provides dual functionality or utility, by providing a method of securing an object to the cooler in the expanded state. The securing mechanism 5 is preferably easily released in order to facilitate conversion of the cooler from the collapsed state to the expanded state. Examples of securing mechanisms include elastic bands, elastic shock cords (“bungee cords”), straps with snap closure mechanisms, straps with hook and eye closures, and so on. The securing mechanism 5 preferable does not interfere with the opening and closing of the top 4 while the cooler is being used in its expanded state. The securing mechanism 5 can also provide additional functionality while the cooler is in its expanded state. For example, an elastic shock cord could be used to hold towels, napkins, cups, or other items against the cooler 1 as a form of external storage.

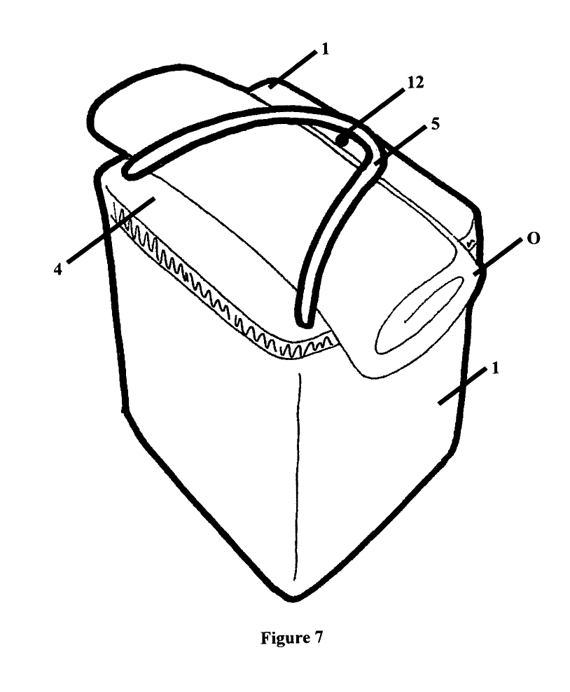

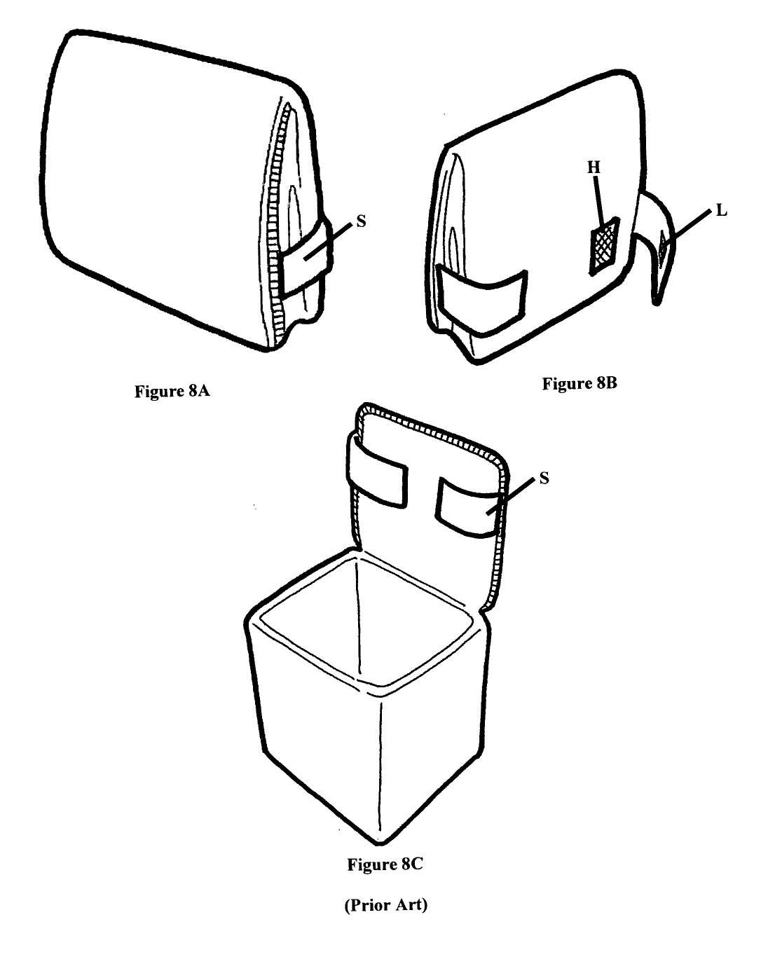

Referring to FIG. 7, the cooler 1 is shown in the expanded state. An object “O” is shown secured to the top, in this example, of the cooler 1. Of course, the object “O” could be a towel as shown, or a newspaper, umbrella, or any other type object the user may want to carry along with the cooler 1. The securing mechanism 5 is shown sandwiching the object O to the top of the cooler now selectively secured to the top 4 of the cooler 1 by being stretched such that an end connects to retention device 12. Of course, as described above, the retention device 12 could be placed elsewhere such that the object O may be sandwiched against a side or bottom of the cooler or generally anywhere against the cooler 1. In this way, the securing mechanism 5 provides the cooler with dual utility or functionality.

The cooler can further comprise various features such as a waterproof liner, one or more handles 7, a shoulder strap 9, one or more external pockets 10, a side slip pocket 11, one or more internal partitions, one or more internal pockets suitable for holding an ice pack, and so on.

An alternative embodiment of the invention is a cooler comprising one wall that confers a spherical shape to the cooler when in its expanded form. The cooler can comprise a linear or curved opening through which the user can access the interior space 6 of the cooler. The opening can generally be any shape, such as a line, an arc, a “C” shape, and so on. The opening can be reversibly closed by use of a reversible attachment. The reversible attachment can generally be any type of reversible attachment such as a zipper or an elastic fitting. A user can collapse the cooler into a compact ball shape for storage. The cooler can comprise a securing mechanism 5 effective to hold the cooler in its collapsed state. The securing mechanism 5 can be any of those previously discussed. The cooler can further comprise any of the various features discussed in the previous paragraph.

All of the articles disclosed and claimed herein can be made and executed without undue experimentation in light of the present disclosure. While the articles of this invention have been described in terms of preferred embodiments, it will be apparent to those of skill in the art that variations may be applied to the articles described herein without departing from the concept and scope of the invention. All such similar substitutes and modifications apparent to those skilled in the art are deemed to be within the scope and concept of the invention.

Although various embodiments have been shown and described herein, the invention is not so limited and will be understood to include all modifications and variations as would be apparent to one skilled in the art.

1. A cooler comprising:
four sides comprised of soft side material to form a rectangle;
a top comprising soft side material attachable to each of the sides;
a bottom comprising soft side material attachable to each of the side, wherein the cooler has an expanded state and a compressed state; and
an elastic strap attachable to the top, wherein the elastic strap or shock cord retains the cooler in the compressed state.

2. The cooler of claim 1, wherein the elastic strap is adapted t secure an item to the top of the cooler while the cooler in the expanded state.

3. The cooler of claim 1, wherein the cooler further comprises an interior ice pack pocket.

4. The cooler of claim 1, wherein the cooler further comprises a heat sealed liner.

5. A cooler comprising:
a bottom;
at least one side;
a top, wherein at least one of the bottom, at least one side, or top comprises a substantially pliable material, such that the cooler is adapted to be collapsed from an expanded state; and
means for retaining the cooler in a collapsed state.

6. The cooler of claim 5, wherein the means for retaining the cooler in a collapsed state is an elastic band.

7. The cooler of claim 5, wherein the means for retaining the cooler in a collapsed state is an elastic shock cord.

8. The cooler of claim 5, wherein the means for retaining the cooler in a collapsed state is a strap in combination with snaps.

9. The cooler of claim 5, wherein the means for retaining the cooler in a collapsed state is adapted to secure an item to an exterior of the cooler when the cooler is in an expanded state.

10. The cooler of claim 5, wherein the top is reversibly attachable to the at least one side.

11. The cooler of claim 10, wherein the top is reversibly attachable to the at least one side with a zipper or elastic fitting.

12. The cooler of claim 5, wherein the bottom, at least one side, and top define a waterproof cavity.

13. The cooler of claim 12, wherein the cooler further comprises at least one internal partition or internal pocket.

14. The cooler of claim 5, wherein at least one of the top, at least one side, or bottom comprises an insulated material.

15. The cooler of claim 5, wherein the cooler further comprises at least one handle, shoulder strap, or external pocket.

16. The cooler of claim 5, wherein at least one of the top or bottom comprises a substantially rigid material.

17. The cooler of claim 5, wherein at least one of the top, at least one side, or bottom comprises at least one of polyvinylchloride, nylon, fabric, or foam.

18. The cooler of claim 5, wherein the top, at least one side, and bottom define a cylindrical cavity.

19. The cooler of claim 5, in which the means for retaining the cooler in the collapsed state is also adapted t secure an item to the top of the cooler while the cooler in the expanded state.

20. The cooler of claim 19 in which the means for retaining the cooler in the collapsed state is an elastic strap.
